(19) United States
(12) Patent Application Publication
(10) Pub. No.: US 2018/0149757 A1
(43) Pub. Date: May 31, 2018

(54) Receiver for Multiple Geographical Positioning Technologies

(71) Applicant: MMRFIC Technology Pvt. Ltd., Bangalore (IN)

(72) Inventors: Ganesan Thiagarajan, Bengaluru (IN); Saravanakumar Ganeshan, Bengaluru (IN)

(21) Appl. No.: 15/427,053

(22) Filed: Feb. 8, 2017

(30) Foreign Application Priority Data
Nov. 30, 2016 (IN) 201641040868

(51) Int. Cl. G01S 19/32

(52) U.S. Cl. CPC G01S 19/32

(57) ABSTRACT

According to present disclosure, a navigational device comprises a radio frequency (RF) receiver section providing a digital baseband signal streams carrying information bands from plurality of satellite systems and a processor determining position information from the digital baseband signal stream, in that, the processor sends control bits to the RF receiver to include information from at least one information band from at least one satellite systems in the digital baseband signal streams. Further, the RF receiver section comprises the first mixer and a second mixer to convert plurality of RF signals received from the plurality of satellite systems into the digital baseband signal stream and the control bits selects a first reference signal and a second reference signal for mixing at the first mixer and the second mixer to include the information from first satellite system and a second satellite system in the digital baseband signal streams.

### CROSS REFERENCES TO RELATED APPLICATIONS

This application claims priority from Indian patent application No. 201641040868 filed on Nov. 30, 2016 which is incorporated herein in its entirety by reference.

### BACKGROUND

### Technical Field

The present disclosure relates generally to geographical positioning systems and in particular to a receiver for multiple geographical positioning technologies.

### Related Art

The geographical positioning/location technologies/system transmit RF signals from their respective set of satellites (satellite system) for Geographical positioning. Receiver receiving the RF signal from the satellite system performs several signal processing and ranging operations to determine the receiver location/position. Each geographical positioning satellite systems (satellite system) employ respective non overlapping communication parameters such as frequency bands, modulation techniques, for example. The receivers are conventionally deployed to receive and process RF signal from one satellite system.

### SUMMARY

According to present disclosure, a navigational device comprises a radio frequency (RF) receiver section providing a digital baseband signal streams carrying information bands from plurality of satellite systems and a processor determining position information from the digital baseband signal stream, in that, the processor sends control bits to the RF receiver to include information from at least one information band from at least one satellite systems in the digital baseband signal streams. Further, the RF receiver section comprises the first mixer and a second mixer to convert plurality of RF signals received from the plurality of satellite systems into the digital baseband signal stream and the control bits selects a first reference signal and a second reference signal for mixing at the first mixer and the second mixer to include the information from one or more satellite systems in the digital baseband signal streams.

In an embodiment, the navigational device further comprises a multiplexer selecting the first reference signal and a second reference signal from a plurality of reference signals based on the control bits. A plurality of dividers generating the plurality of reference signals comprising the first and the second reference signals from a local oscillator signal and a phase locked loop generating the local oscillator signal at the local oscillator frequency (LO).

Several aspects are described below, with reference to diagrams. It should be understood that numerous specific details, relationships, and methods are set forth to provide a full understanding of the present disclosure. One who skilled in the relevant art, however, will readily recognize that the present disclosure can be practiced without one or more of the specific details, or with other methods, etc. In other instances, well-known structures or operations are not shown in detail to avoid obscuring the features of the present disclosure.

### BRIEF DESCRIPTION OF DRAWINGS

FIG. 1 is an example conventional system for geographical positioning.

FIG. 2 is a block diagram of an example navigation device in an embodiment.

FIG. 3 is a block diagram of an RF section in one embodiment.

FIG. 4 depicts an example crystal oscillator frequency and the references.

FIG. 5 is a table illustrating selection of reference signal in one embodiment.

FIG. 6 is a table illustrating selection of reference signal for providing information of more than one satellite system simultaneously in an embodiment.

FIG. 7 is a block diagram of the RF section in an alternative embodiment.

FIG. 8 is a table illustrating selection of bands and the reference frequencies.

### DETAILED DESCRIPTION OF THE PREFERRED EXAMPLES

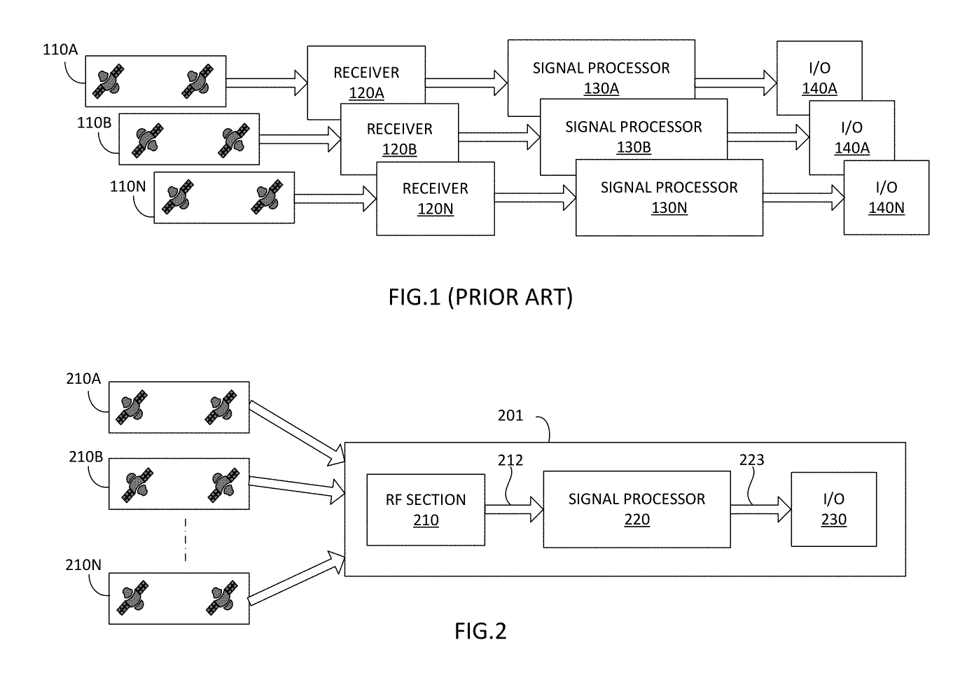

FIG. 1 is an example conventional system for geographical positioning. As shown there conventional system comprises satellite group 110A through 110N, receiver 120A through 120N, signal processor 130A through 130N, input & output (I/O) interface 140A through 140N. Each element is further described below.

The each satellite group (satellite system) 110A through 110N corresponds to different geographical positioning system. For illustration, the group of satellites 110A represents NAVSTAR Global Navigation Satellite System (GNSS) of the USA. The group of satellites 110A transmits two RF signals referred to as L1 and L2, in that, L1 is centered at 1575.5 MHz and L2 is centered at 1227.6 MHz. The group of satellites 110B represents Global Navigation Satellite System (GLONASS) of Russia. The group of satellites 110B transmits the RF signal centered at 1602 MHz. The group of satellites 110N represents Indian Regional Navigation Satellite System (IRNSS). The group of satellites 110N transmits two RF signals referred to as L5 and S, in that the L5 is centered at 1176.45 MHz and S is centered at 2492.08 MHz. The group of satellites 110K (not shown) represents Galileo satellite navigation system of European Union and so on.

The receiver 120A through 120N respectively receives the RF signal from group of satellites 110A through 110N. As per the illustration, receiver 120A receives one of L1 or L2 signal, receiver 120B receives GLONASS signal, the receiver 120C receives one of L5 and S signal. The signal so received is conditioned for further processing, for example, operations such as filtering, amplifying, mixing down converting are performed.

The signal processor 130A through 130N receives the conditioned signal from the respective receiver 120A through 120N and performs various mathematical operations to determine the location/position. The mathematical operation may comprise signal acquisition, synchronization, decoding, ranging, triangulation and other operations well known in the art. The determined position information is provided to I/O devices.

The Input/output devices 140A through 140N receives position information from the corresponding signal processor 130A through 130N and provides position information on an output device such as display device. The I/O devices 140A through 140N may comprise touch screen device, display device, USB ports, standard data transfer bus, wireless modem, memory, for example. The position information may be provide on the output device on a geographical map or in any other format based on the command received on the input device like, key board, mouse, touch screen, etc.

In a conventional navigation devices, one or more receivers 120A through 120N, signal processor 130A through 130N are deployed to provide position information and/navigational functionality. For example, a navigational device required to support navigational features from two are more geographical position systems deploy corresponding number of receivers, signal processors. Deployment of multiple receivers and/or multiple signal processors to support two or more geographical position systems is inefficient at least in terms of area and cost.

FIG. 2 is a block diagram of an example navigation device in an embodiment. The navigational device 201 is shown comprising RF section 210, processor 220 and I/O device 230. The device 201 is shown receiving RF signal from the satellite system 210A through 210N, in that 210A represents the NAVSTAR satellite group, 210B represents GLONASS satellite group, 210C represents the IRNSS satellite group, in an embodiment. Each element of the device 201 is further described below.

The RF section 210 receives RF signals from the satellite systems 210A through 210N and provide conditioned intermediate frequency (IF) signal suitable for further processing via path 212. The RF section may selectively condition RF signal from a desired satellite system 210A through 210N. In another embodiment, the RF section may simultaneously condition more than one RF signals from the satellite systems 210A through 210N. Thus, IF signal may comprise information bands of one or more satellite systems 210A through 210N. The IF signal may be provide on path 212 in analog and/or digital forms.

The signal processor 220 receives processed IF signal on path 212 from the RF section 210 and generate position information. The processor may generate position information based on one or more IF signals corresponding to one or more satellite systems 210A through 210N. The processor 220 further processes each IF signal to extract the information required for computing and determining position, velocity, acceleration and direction (together referred to as position information). For example the processor may perform operation such as filter, amplify, down covert, decode, synchronize etc., to extract range, time, and other information (such as ephemeris for example). In one embodiment, the processor generates final position information from a set of position information's derived from the corresponding set of satellite systems. For example, the processor may compare, the set of position information's to produce the final position information.

The I/O device 230 provides the position information in a suitable format for external interface. For example, in case of a display device, the set of position information's and/or final position information may be displayed on a map either selectively or together. The I/O device 230 may operate similar to the I/O device 140A thorough 140N. Due to single RF section 210 to process RF signal from more than one satellite system, at least the space and the cost is reduced. Further, due to one RF section, single processor or multiple processors may be deployed to provide more accurate position information based decoded ranges of more than one satellite system. The manner in which the RF section 210 may be deployed for providing more than one IF signals corresponding more than one satellite system selectively or together is further described below.

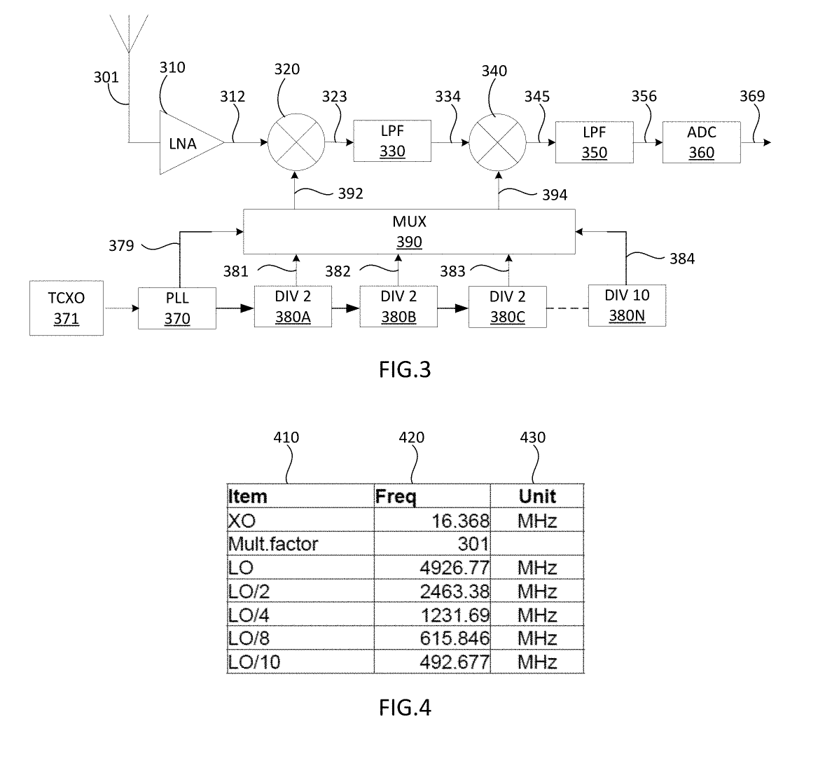

FIG. 3 is a block diagram of an RF section in one embodiment. The RF section is shown comprising RF antenna 301, low noise amplifier (LNA) 310, mixers 320 and 340, low pass amplifiers (LPF) 330 and 350, analog to digital converter (ADC) 360, Phase locked loop (PLL) 370, temperature compensated crystal oscillator TCXO 371, dividers 380A, 380B, 380C through 380N, and multiplexer (MUX) 390. Each block is further described below.

The LNA 310 amplifies the RF signal received through antenna 301. The LNA amplifies signal received on antenna 301 without adding its own operational noise (amplifier noise significantly). The LNA may be implemented with constant gain across frequency ranges of the satellite systems 210A-210N. The LNA 310 may be implemented as an electronic amplifier that amplifies a very low-power signal without significantly degrading its signal-to-noise ratio. Although, one LNA per system of satellites is shown here for illustration, this may be implemented with multiple LNAs, one per band or system of satellites for example, for improving the power efficiency or performance of the Geo-location system.

The mixer 320 and LPF 330 together operate to down convert the RF signal to a first intermediate frequency signal. In that mixer 320 mixes the RF signal with a local oscillator signal received on path 392 to generate an output comprising sum, difference other harmonic combination of RF signal and the local oscillator signal 392 as is well known in the art. The LPF 330 passes the signal centered at a desired frequency (for example, centered at difference frequency) to provide signal centered at the first intermediate frequency on path 334.

Similarly, the mixer 340 and LPF 350 together operate to down convert the signal on path 334 (centered at first intermediate frequency) to a second intermediate frequency signal. In that mixer 330 mixes the RF signal with a local oscillator signal received on path 394 to generate an output comprising sum, difference other harmonic combination of first intermediate frequency signal and the local oscillator signal 394. The LPF 350 passes the signal centered at a desired frequency (for example, centered at difference frequency) to provide signal centered at the second intermediate frequency on path 356.

The ADC 360 converts the second intermediate frequency signal into digital data sequence for further processing by the processor 220. In that, the ADC 360 may sample the second intermediate frequency signal at a sampling rate (Nyquest rate, for example) suitable to adequately extract information contained in the RF signal. The ADC 360 may convert each sample into sequence of information bits. The information bits are provided on path 369 (to processor 220 for example).

The PLL 370 generates a signal with a substantially constant frequency referred to as local oscillator frequency (LO) from a continuous periodic signal received from the temperature compensated crystal oscillator (TCXO) 371. The PLL 370 may be implemented in any known ways to generate stable and constant frequency signal. The local oscillator frequency (LO) is provided on path 379 and to dividers 380A, 380B, 380C through 380N as may be appropriate.

The divider 380A, 380B, 380C through 380N divides a received signal by an integer value. For example, divider 380A generates a reference signal of frequency LO/2, divider 380B generates a reference signal of frequency LO/4, and divider 380C generates a reference signal of frequency LO/8. The divider 380N divides frequency of an incoming signal by a factor 10 (for example). In one embodiment, the divider 380K (not shown) generates a reference signal with a frequency LO/80. Reference signals from the divider 380A, 380B, 380C through 380N (respectively at frequency LO/2, LO/4, LO/8, LO/10, LO/120 so on (for example) are respectively provided on path 381, 382, 383, 384 so on.

An example crystal oscillator frequency and the references signals are depicted in FIG. 4. As shown there the column 410 represents the reference signal, column 420 represents the corresponding frequency value and the column 430 represents unit of the frequency. In that, XO represents example TXCO frequency and shown as 16.368 MHz, LO represents the reference signal on path 379 and shown as 4926 MHz, and LO/2, LO/4, LO/8 and LO/10 respectively represent reference signals provided on path 381, 382, 383, 384 for example.

The multiplexer 390 selectively provides two reference signals on path 392 and 394. The two reference signals are selected from paths 379, 381, 382, 383, 384 for example. The multiplexer may select the reference signals based on control bits received from processor 220 and/or through I/O device 230.

In one embodiment, the multiplexer 390 dynamically connects the reference signals to path 392 and 394 such a way that the information from one of the satellite system 210A through 210N is provided on the path 369. In an alternative embodiment, the multiplexer connects the reference signal on path 392 and 394 such a way that the information from more than one satellite systems is provided on path 369. The manner in which the information from one or more satellite systems are coupled to path 369 is further described below.

FIG. 5 is a table illustrating selection of reference signal in one embodiment. In the table, the example satellite systems are listed on column 510, the column 520 represents selection of reference frequency on path 392, the column 530 represents selection of reference frequency on path 394, the column 540 represents center frequency of first intermediate signal (IF1) on path 323, the column 550 represents center frequency of second intermediate signal (IF2) on path 334, the column 560 represents the center frequencies for each of the satellite system signal (arranged) in an ascending order. That is, the second IF2 signal frequencies are arranged in ascending order in column 560. 570 represents the consecutive difference between the second IF frequencies, which shows the separation between them in the combined baseband signal digitized by the ADC. The values in the table are in MHz.

As may be seen the information from the NAVSTAR (GPS) L1 band is coupled to the path 369 when multiplexer 390 is configured to couple LO/4 on path 392, LO/14 on path 394 from the dividers 380A through 380N and the LPF 330 is configured to pass difference of RF signal frequency and LO/4 (i.e. Fc−LO/4) and the LPF 350 is configured to pass difference of LO/14 and first intermediate frequency (LO/14−IF1). In that Fc represents the center frequency of the RF signal corresponding to their respective satellite bands.

Similarly, the information from the GLONASS is coupled to the path 369 when multiplexer 390 is configured to couple LO/4 on path 392, LO/14 on path 394 from the dividers 380A through 380N and the LPF 330 is configured to pass difference of RF signal frequency and LO/4 (Fc−LO/4) and the LPF 350 is configured to pass difference of first intermediate frequency and LO/14 (IF1−LO/14).

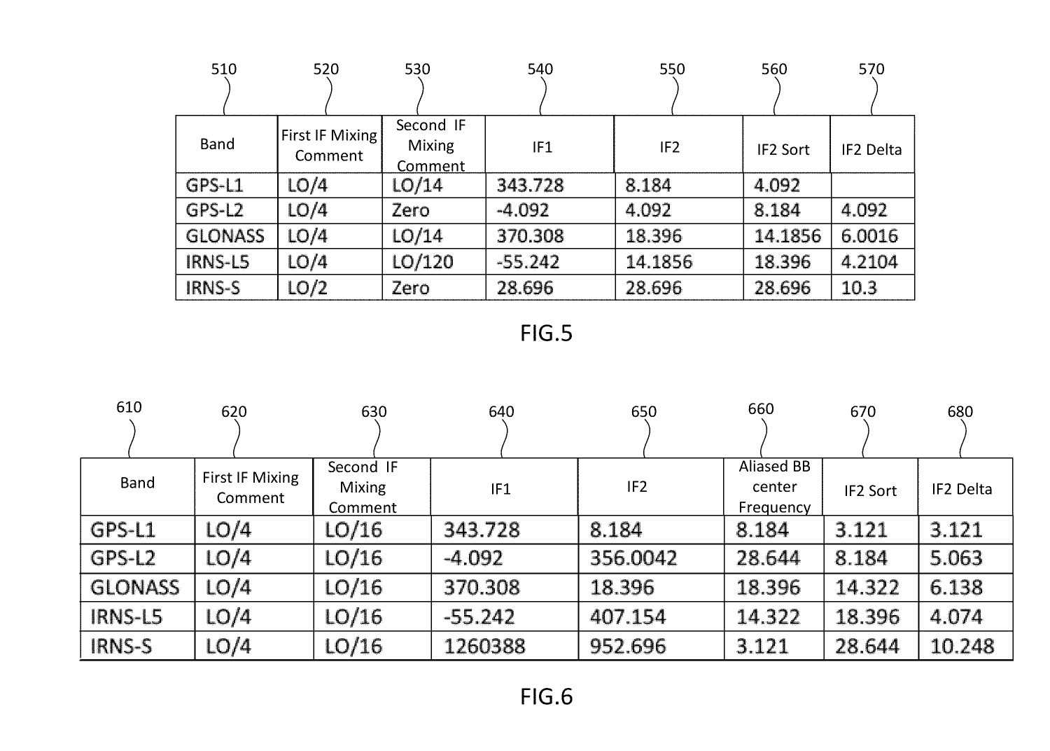

FIG. 6 is a table illustrating selection of reference signal for providing information of more than one satellite system simultaneously in an embodiment. In the table, the example satellite systems are listed on column 610, the column 620 represents selection of reference frequency on path 392, the column 630 represents selection of reference frequency on path 394, the column 640 represents center frequency of first intermediate signal (IF1) on path 323, the column 650 represents the center frequency of second intermediate signal (IF2) on path 334, the column 660 represents the aliased baseband center frequency, In this case, the ADC sampling rate is fixed at 65.472 MHz. Hence some of the signals with higher Fc (e.g., 356 MHz) will alias back to 28.644 MHz. We are exploiting this spectral fold over to reduce the ADC sampling rate. The column 670 represents the center frequencies for each of the satellite system signal (arranged) in an ascending order. That is, the second IF2 signal frequencies are arranged in ascending order in column 670. The column 680 represents the consecutive difference between the second IF frequencies, which shows the separation between them in the combined baseband signal digitized by the ADC. The ADC 360 is operated at rate 65.472 MHz. The baseband signal corresponding to each of the satellite system can be separated by applying bandpass filter centered at the frequencies listed in Column 660, by well known methods.

Accordingly, the multiplexer 390 selects LO/4 reference frequency signal to path 392 and LO/16 reference frequency signal to path 394 thereby passing information from all the satellite systems to the path 369. Due to selection of the frequency as in the FIG. 6 the natural aliasing is exploited to separate the bands in the baseband and the ADC 360 is operated at a reduced rate. Thus, the information from the satellites are concurrently processed and digitized in a single receiver. However, some bands may experience higher noise floor (level) compared to other bands. The manner in which such disadvantage may be overcome is further described below.

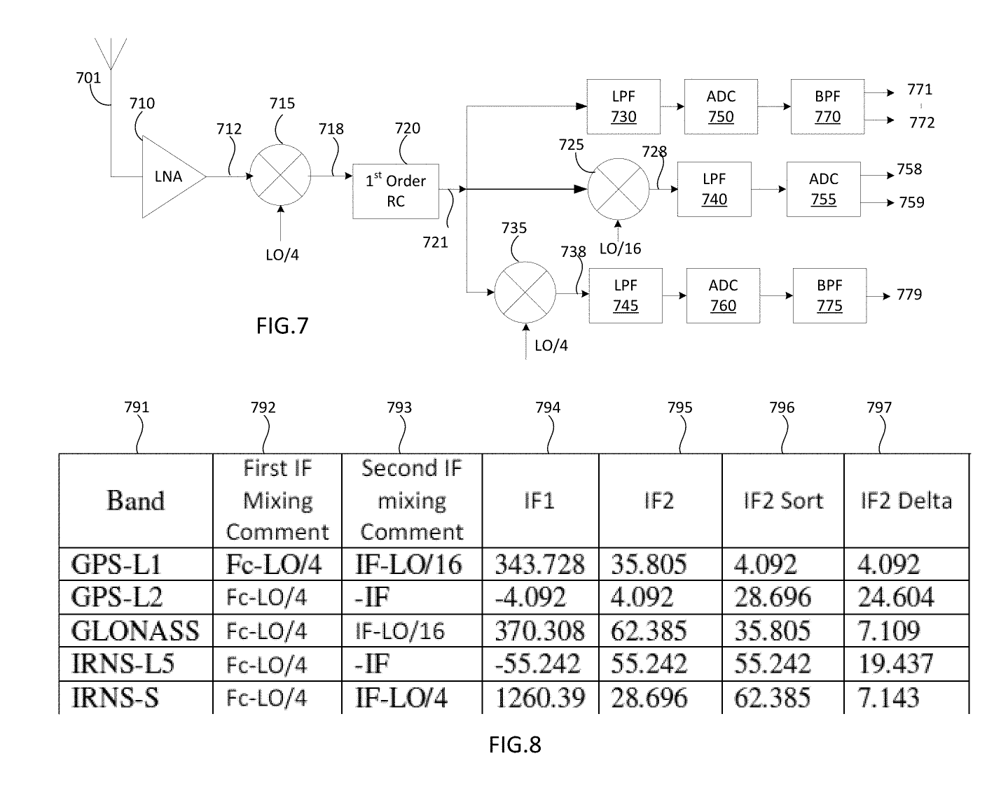

FIG. 7 is a block diagram of the RF section in an alternative embodiment. The RF section is shown comprising RF antenna 701, low noise amplifier (LNA) 710, mixers 715, 725 and 735, first order RC filter 720, low pass filters (LPF) 730, 740 and 745, analog to digital converters (ADC) 750, 755, and 760, and band pass filters (BPF) 770 and 775. Each block is further described below referring to example values in FIG. 8 (table).

The RF antenna 701, low noise amplifier (LNA) 710 operates similar to the RF antenna 701, low noise amplifier (LNA) 710. In combination, RF Antenna 701 and LNA 710 provide RF signal comprising the frequency bands of satellite system 210A through 210N on path 712. In one embodiment the signal on path 712 comprises NAVSTAR L1 and L2 band RF signals, GLONASS RF signal, INRS L5 and S band RF signals.

The mixer 715 down converts the RF signal received on path 712 to a first intermediate frequency signal comprising frequency bands of satellite system 210A through 210N centered at corresponding lower frequencies (down converted satellite bands). In one embodiment, the mixer 715 receives reference frequency signal of LO/4 (i.e. 4926.77 MHz/4, as shown in the column 792) from multiplexer 390, for example, and provide first intermediate frequency signal on path 718 comprising (as shown in column 794) NAVSTAR L1 band centered at 343.728 MHz, NAVSTAR L2 band centered at −4.092 MHz, GLONASS band centered at 370.308 MHz, IRNS L5 band centered at −55.242 MHz, and IRNS S band centered at 1260 MHz. The first order RC filter 720 filters the signal on path 718 to pass frequency less than a cut off frequency on to path 721. In one embodiment the cutoff of frequency of the first order RC filter is set at 1.28 GHz there by passing all the down converted satellites bands.

The LPF 730, ADC 750 and BPF 770 together operate to provide only the information from the desired satellite system (for example, 210A). In that LPF 730 further filters the signal on path 721 to allow the bands of desired satellite system. In one embodiment the cutoff frequency of the LPF 230 is set 64 MHz to allow bands comprising the information of NAVSTAR L2 band and IRNS L5 band. The ADC 750 converts the filtered signal to digital bit stream. In one embodiment the ADC operate at 130 MHz. The BPF 770 filters the digital stream of harmonics due to digitization and separates the IRNS L5 band and NAVSTAR L2 band. The separated IRNS L5 band and NAVSTAR L2 band are respectively provided on path 771 and 772 (to processor 220).

Similarly, the mixer 725 further down converts the signal on path 721 to second intermediate frequency comprising bands of the satellite systems 210A through 210N centered at corresponding second lower frequencies. In one embodiment, the mixer 725 receives reference frequency signal of LO/16 (as in column 793) from multiplexer 390, for example, and provide second intermediate frequency signal on path 728 (as in column 795) comprising NAVSTAR L1 band centered at 35.802 MHz, and GLONASS band centered at 62.385 MHz. The LPF 740 and ADC 755 together operate to provide only the information from the desired satellite system. In that LPF 740 further filters the signal on path 728 to allow the bands of desired satellite system. In one embodiment the cutoff frequency of the LPF 240 is set 64 MHz to allow bands comprising the information of NAVSTAR L1 band and GLONASS band. The ADC 755 converts the filtered signal to digital bit and NAVSTAR L2 are respectively provided on path 758 and 759 (to processor 220).

Similarly, the mixer 735 further down converts the signal on path 721 to third intermediate frequency comprising bands of the satellite systems 210A through 210N centered at corresponding third lower frequencies. In one embodiment, the mixer 735 receives reference frequency signal of LO/4 (as in column 793) from multiplexer 390, for example, and provides third intermediate frequency signal on path 738 comprising IRNS S band centered at 28.696 MHz (as in column 795). The LPF 745 and ADC 760 together operate to provide only the information from the desired satellite system. In that LPF 745 filters the signal on path 738 to allow the bands of desired satellite system. In one embodiment the cutoff frequency of the LPF 745 is set 32 MHz to allow information of IRNS-S. The ADC 760 converts the filtered signal to digital bit stream. The BPF 775 digital filter the unwanted frequency band allowing only the IRNS-S band. The IRNS-S is provided on path 779 (to processor 220).

While various embodiments of the present disclosure have been described above, it should be understood that they have been presented by way of example only, and not limitation. Thus, the breadth and scope of the present disclosure should not be limited by any of the above-discussed embodiments, but should be defined only in accordance with the following claims and their equivalents.

What is claimed is:

1. A navigational device comprising:
a radio frequency (RF) receiver section providing a digital baseband signal stream carrying information bands from plurality of satellite systems; and
a processor determining position information from the digital baseband signal stream, in that, the processor sends control bits to the RF receiver section to include information from at least one information band from at least one satellite systems in the digital baseband signal stream.

2. The navigational device of claim 1, wherein the RF receiver section comprises a first mixer and a second mixer to convert plurality of RF signals received from the plurality of satellite systems into the digital baseband signal stream and the control bits selects a first reference signal and a second reference signal for mixing at the first mixer and the second mixer to include the information from first satellite system and a second satellite system in the digital baseband signal stream.

3. The navigational device of claim 2, further comprising:
a multiplexer selecting the first reference signal and the second reference signal from a plurality of reference signals based on the control bits;
a plurality of dividers generating the plurality of reference signals comprising the first and the second reference signals from a local oscillator signal; and
a phase locked loop generating the local oscillator signal data having local oscillator frequency (LO).

4. The navigational device of claim 3, wherein the LO is 4926.77 MHz and the multiplexer selects the first reference signal having a frequency LO/4 and selects the second reference signal having a frequency LO/16 and the digital baseband signal stream comprises information bands of satellite systems GPS-L1, GPS-L2, GLONASS, IRNS-L5 and IRNS-S.

5. The navigational device of claim 3, wherein the digital baseband signal stream comprises information bands of satellite systems of GPS-L1 and GLONASS when the multiplexer selects the first reference signal with frequency LO/4 and the second reference signal with a frequency LO/14.

6. The navigational device of claim 3, wherein the digital baseband signal stream comprises information band of satellite system of IRNS-L5 when the multiplexer selects the first reference signal with frequency LO/4 and the second reference signal with a frequency LO/120.

7. The navigational device of claim 3, further comprises a first low pass filter (LPF) and a second low pass filter, wherein the first mixer and the first LPF generate a first intermediate frequency (IF) signal from the RF signal, and the second mixer and second LPF generate a baseband signal from the first IF signal.

8. The navigational device of claim 7, further comprising a analog to digital converter (ADC) converting the baseband signal to produce the digital baseband signal stream, wherein the ADC sampling rate is set to fold over the frequency component back to within Nyquist frequency of the ADC.

9. The navigational device of claim 8, wherein the sampling rate of ADC is set to 65.472 MHz.
